(19) United States
(12) Patent Application Publication
(10) Pub. No.: US 2013/0167381 A1
(43) Pub. Date: Jul. 4, 2013

(54) LINER LOCK APPARATUS AND METHOD

(71) Applicant: Browning, Morgan, UT (US)

(72) Inventor: Russ KOMMER, Fargo, ND (US)

(73) Assignee: BROWNING, Morgan, UT (US)

(21) Appl. No.: 13/728,364

(22) Filed: Dec. 27, 2012

Related U.S. Application Data
(60) Provisional application No. 61/580,476, filed on Dec. 27, 2011.

(51) Int. Cl. B26B 1/04

(52) U.S. Cl. CPC B26B 1/044
USPC 30/161; 29/434

(57) ABSTRACT

A folding knife includes a handle, a knife blade rotatably attached to the handle, the knife blade including a tang, a liner positioned within the handle, the liner further comprising a liner lock, and a safety device. The liner lock has a first position when the knife is in a closed position, and has a second position when the knife blade is in a deployed or open position. An end of the liner lock engages the tang of the knife. A safety device is positioned between the liner lock and the handle when the knife blade is in the deployed or open position.

### RELATED APPLICATION

This application claims the benefit of U.S. Provisional Patent Application Ser. No. 61/580,476, filed on Dec. 27, 2011, which is incorporated by reference herein.

### TECHNICAL FIELD

Various embodiments described herein relate to a combination carabineer and tool apparatus and a method of forming and using the same.

### BACKGROUND

People engaged in certain rope intensive activities are familiar with carabineers. Carabineers are widely used in activities such as climbing, caving, sailing, construction, and window cleaning. Carabineers are generally used to connect ropes or to connect to other safety devices in these activities. Generally, carabineers made for the above purposes are built from high grade steel or aluminum that will withstand the forces associated with these activities.

The carabineers used for the above activities are subject to strength standards in both Europe and the United States. For most recreational uses, such as rope climbing, the carabineers are required to have a breaking strength of approximately 5000 pounds. The carabineers for industrial activities generally are required to have an even higher breaking strength according to the standards.

The two broad categories of carabineer are the locking carabineer, and the non-locking carabineer. Non-locking carabineers have a sprung swinging gate that accepts a rope, webbing sling, or other hardware. Rock climbers frequently connect two non-locking carabineers with a short length of nylon web to create a quickdraw. There are three types of swinging gates, namely a straight gate, a bent gate and a wire gate. Locking carabineers have the same general shape as non-locking carabineers but have an additional sleeve securing the gate. These sleeves may be either threaded or spring-loaded twist-lock. The sleeves tend to make the carabineer more secure. It is very important that the carabineers are structurally sound as the users of the devices in these activities actually are relying in on the carabineer to prevent injury, or even save a life.

Recently, carabineers have become popular for additional purposes. Many of these additional purposes are not critical to the safety of people. Carabineers are useful for many light duty outdoor activities. As a result, these carabineers are more lightly built than the carabineers used for climbing, caving, sailing, construction, and window cleaning. These carabineers are used to hook items together, such as hooking a water bottle to a book bag, or hooking keys to the carabineer to form a key chain. Basically, the general public thinks the carabineers look nice and lend them an outdoor-look. Generally, it is not life threatening if a water bottle falls off a book bag. Accordingly, these carabineers have breaking strengths which are less than the breaking strengths set forth in the European and US standards.

In addition, tools include liner locks to prevent unintended movement of a knife blade with respect to a handle or base of a pocket knife or the like. A liner lock holds a blade in a deployed position. There is always a need for a new liner lock.

### SUMMARY OF THE INVENTION

The invention includes a combination carabineer and tool device. The carabineer includes a substantially C-shaped carabineer body. The carabineer body has a first free end and a second free end. The tool is associated with the carabineer. The tool is removably attached to the carabineer. The carabineer body has one of a projection or a slot. The tool has the other of the projection or the slot. The tool is removably attached by engaging the projection with the slot. The carabineer and tool can also include an apparatus to hold the tool in a position with respect to the carabineer. This holding apparatus can be a détente in one of the tool or the carabineer or can be a magnetic latch having a first portion located in the tool and a second portion located in the carabineer.

In one embodiment, the tool is a foldable knife. The foldable knife is movable between a storage position and a deployed position. When moving between these positions, the knife blade passes near the first free end and the second free end of the carabineer body. On most carabineers, a gate is placed between the first free end and the second free end. When moving knife blade of the foldable knife between a storage position and a deployed position, the knife blade passes near the gate.

A combination carabineer and tool device includes a curvilinear body and at least one pocket attached to the curvilinear body of the carabineer. The curvilinear body has an elongated handle member having a first end and a second end, an upper arm member integrally attached to the first end of the elongated handle member, and a lower arm member integrally attached to the second end of said handle member. The caribineer also has a gate element capable of moving between an open position and a closed position. The gate element connects the upper arm member and the lower arm member when in the gate is in its closed position. The pocket attached to one side of the elongated handle member includes an elongated storage slot. The pocket has a first pocket end and a second pocket end. A knife blade is pivotally mounted to one of the first pocket end or the second pocket end. The knife blade pivots between an extended open position outside the storage slot and a closed position within the storage slot. The combination carabineer and tool device further includes a locking assembly for releasably locking the knife blade in the extended open position

### BRIEF DESCRIPTION OF THE DRAWINGS

FIG. 1 is a side view of a combination carbineer and folding knife with the blade of the folding knife in a closed or stored position, according to an example embodiment.

FIG. 2 is a side view of a combination carbineer and folding knife from a side without a pocket, according to an example embodiment.

FIG. 3 is a side view of a combination carbineer and folding knife with the knife in a deployed position, according to an example embodiment.

FIG. 4 is a top view of a combination carbineer and folding knife with the knife in a deployed position, according to an example embodiment.

FIG. 5 is a perspective view of a combination carbineer and tool, according to an example embodiment.

FIG. 6 is a perspective view of a tool, such as a knife, separated from the carbineer combination carbineer and tool, according to an example embodiment.

FIG. 7 is a perspective view of an attachment side of the carbineer, according to an example embodiment.

FIG. 8 is a close up perspective view of a tool, such as a knife, showing one end of the projection or projections, according to an example embodiment.

FIG. 9 is a close up perspective view of a tool, such as a knife, showing another end of the projection or projections, according to an example embodiment.

FIG. 10 is a perspective view of a carabineer having a channel or channels, according to an example embodiment.

FIG. 11 is a side view of a folding knife with the blade of the folding knife in a closed or stored position, according to an example embodiment.

FIG. 12 is a side view of a folding knife with the blade of the folding knife in an opened and locked position, according to an example embodiment.

FIG. 13 is a top view of a folding knife with the blade of the folding knife in a closed or stored position, according to an example embodiment.

FIG. 14 is a top view of a folding knife with the blade of the folding knife in an opened and locked position, according to an example embodiment.

FIG. 15 is another side view of a folding knife with the blade of the folding knife in an opened and locked position, according to an example embodiment.

FIG. 16 is a perspective view of a portion of a knife with the blade in the closed position, according to an example embodiment.

FIG. 17 is a top view of a portion of a knife with the blade in the closed position, according to an example embodiment.

FIG. 18 is a perspective view of a portion of a knife with the blade in the open and locked position, according to an example embodiment.

FIG. 19 is a top view of a portion of a knife with the blade in the open and locked position, according to an example embodiment.

### DETAILED DESCRIPTION

This has been a detailed description of some exemplary embodiments of the invention(s) contained within the disclosed subject matter. Such invention(s) may be referred to, individually and/or collectively, herein by the term “invention” merely for convenience and without intending to limit the scope of this application to any single invention or inventive concept if more than one is in fact disclosed. The detailed description refers to the accompanying drawings that form a part hereof and which shows by way of illustration, but not of limitation, some specific embodiments of the invention, including a preferred embodiment. These embodiments are described in sufficient detail to enable those of ordinary skill in the art to understand and implement the inventive subject matter. Other embodiments may be utilized and changes may be made without departing from the scope of the inventive subject matter. Thus, although specific embodiments have been illustrated and described herein, any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

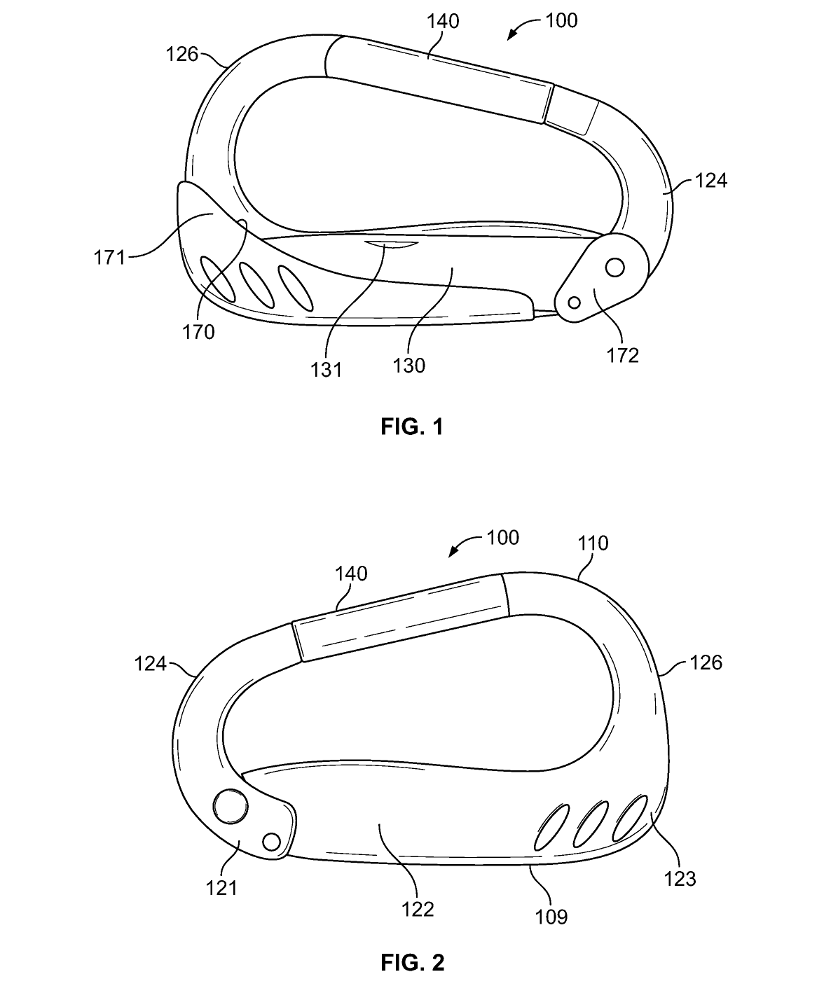

FIG. 1 is a side view of a combination carbineer and folding knife 100 with the blade 131 of the folding knife 130 in a closed or stored position, according to an example embodiment. FIG. 2 is a side view of a combination carbineer and folding knife 100 from a side without a pocket 120, according to an example embodiment. A combination carabineer and tool device 100 includes a carabineer 110 and at least one pocket 120 attached to the carabineer 110. The carabineer 110 has a curvilinear body 109. The curvilinear body 109 has an elongated handle member 112 having a first end 111 and a second end 123. An upper arm member 124 integrally attached to the first end 121 of the elongated handle member 122, and a lower arm member 126 integrally attached to the second end 123 of the elongated handle member 122. The carabineer 110 also has a gate element 140 capable of moving between an open position and a closed position. The gate element connects the upper arm member 124 and the lower arm member 126 when in the gate 140 is in its closed position. The pocket 170 is attached to one side of the elongated handle member 122 includes an elongated storage slot 128. The pocket 170 has a first pocket end 171 and a second pocket end 172. A knife blade 130 is pivotally mounted to one of the first pocket end 171 or the second pocket end 172. The knife blade 130 pivots between an extended open position outside the storage slot 170 and a closed position within the storage slot 170. The combination carabineer and tool device 100 further includes a locking assembly 150 for releasably locking the knife blade 130 in the extended open position. The pocket 170 includes a liner. The locking assembly, in a pocket with a liner, can include a liner lock 151.

In one embodiment, the knife blade 131 is foldable between a stored or stowed position and an open position. In one embodiment, the knife blade 131 passes proximate the gate 140 as the blade 130 is moved between the open position and the stored position. In another embodiment, the knife blade 131 passes away from the gate 140 as the blade 131 is moved between the open position and the closed, stored or stowed position. The knife blade 131 can include a nail nick 132 which is used to move the knife blade 131.

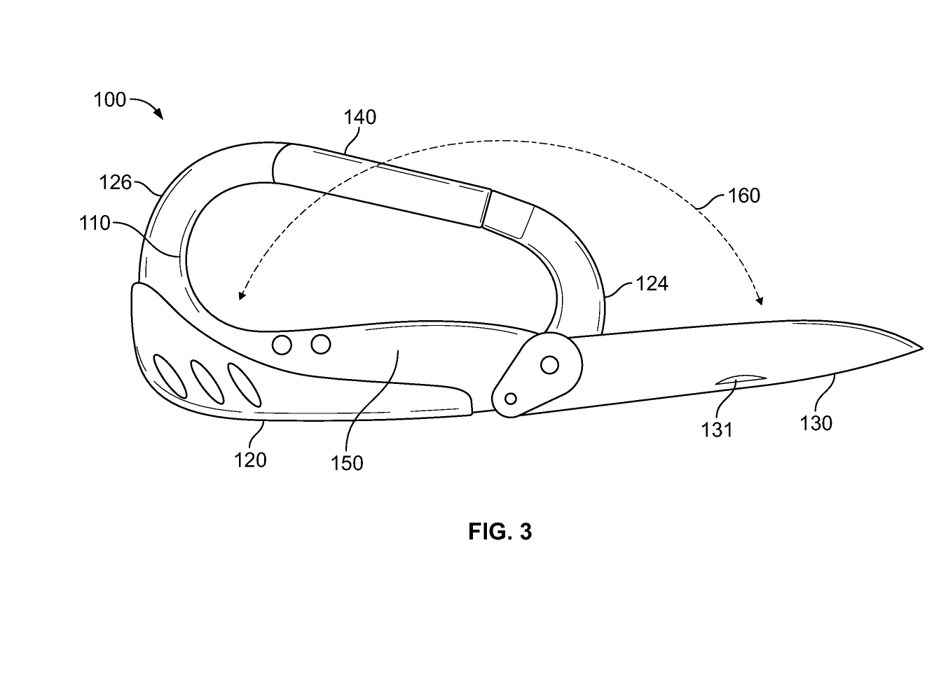

FIG. 3 is a side view of a combination carbineer and folding knife 100 with the knife 131 in a deployed position, according to an example embodiment. With a blade 131 a deployed position, the pocket 170 is more visible. The pocket 170 has a first pocket end 171 and a second pocket end 172. The knife blade 131 is rotatably attached to one of the first pocket end 170 one or the second pocket end 172. As shown in FIG. 1, the knife blade 131 is rotatably attached to the second pocket end 172. The knife blade 131 includes a tip 132. FIG. 3 also shows the path of the knife blade tip 132, as depicted by reference numeral 160. The knife blade 130 passes proximate the gate 140 as is moved from a deployed position to a closed position and vice versa. The knife blade 131 also passes over the upper arm 124 and the lower arm 126 and the space between the upper arm 124, the lower arm 126, the gate 140, and the elongated handle 122. The pocket 170 also includes a liner lock 150. The liner lock 150 is attached to the side of the pocket 170. The liner lock 150 is spring-loaded such that when the blade 131 is in the deployed position it is automatically locked in that position. This keeps the knife blade 131 in the deployed position until the liner lock 150 is released to allow the knife blade 131 to be moved to the stored position within the pocket 170.

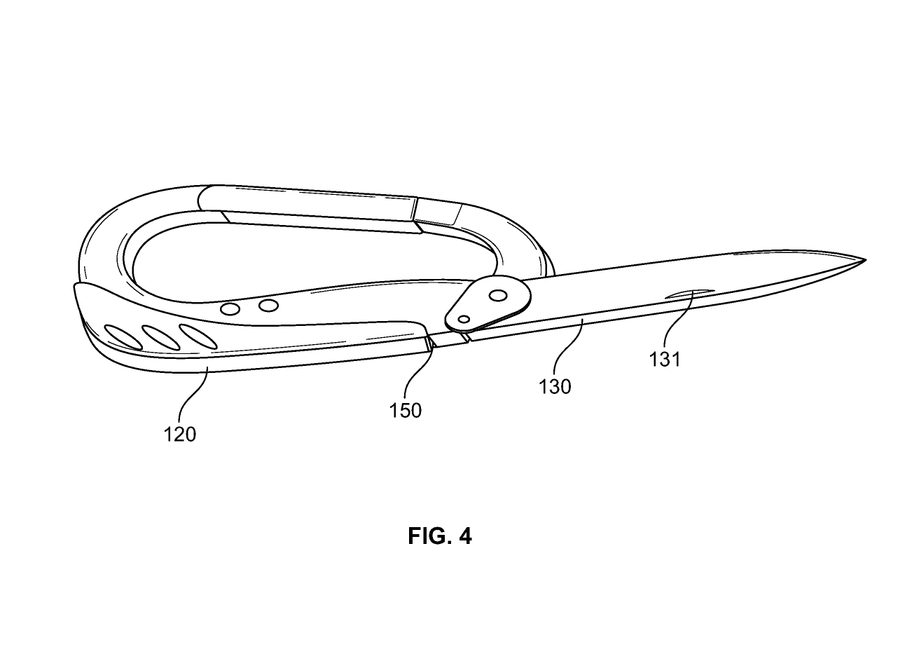

FIG. 4 is a top view of a combination carbineer and folding knife 100 with the knife blade 131 in a deployed position, according to an example embodiment. The liner lock 150 is positioned so that the locks the blade 131 in place or in its deployed position. The pocket 170, more specifically, is connected to the elongated handle member 122 of the carabineer 110. The pocket 170 is fixed in place to the side of the carabineer 110. The pocket includes the first pocket end 171, and the second pocket end 172, as shown in FIG. 1. The gate 140 is a solid piece of aluminum or other cylindrical metal. In other embodiments, the gate 140 can be a wire type gate or a screw on type gate. The gate 140 can also be a locking gate which includes a threaded mechanism to attach the gate 140 to one of the first end first end 121 or the second end 123 of the carabineer 110.

The carabineer device 110 includes a curvilinear body 109 which also has an elongated handle member 122. The curvilinear body also includes a first end 121 and a second end 123. An upper arm member 124 is integrally attached to the first end of the elongated handle member 122, and a lower arm member 126 integrally attached to the second end 123 of the elongate handle member. The carabineer device 110 also includes a gate element 140 capable of moving between an open position and a closed position. The gate element connects the upper arm member 124 and the lower arm member 126 when in the closed position.

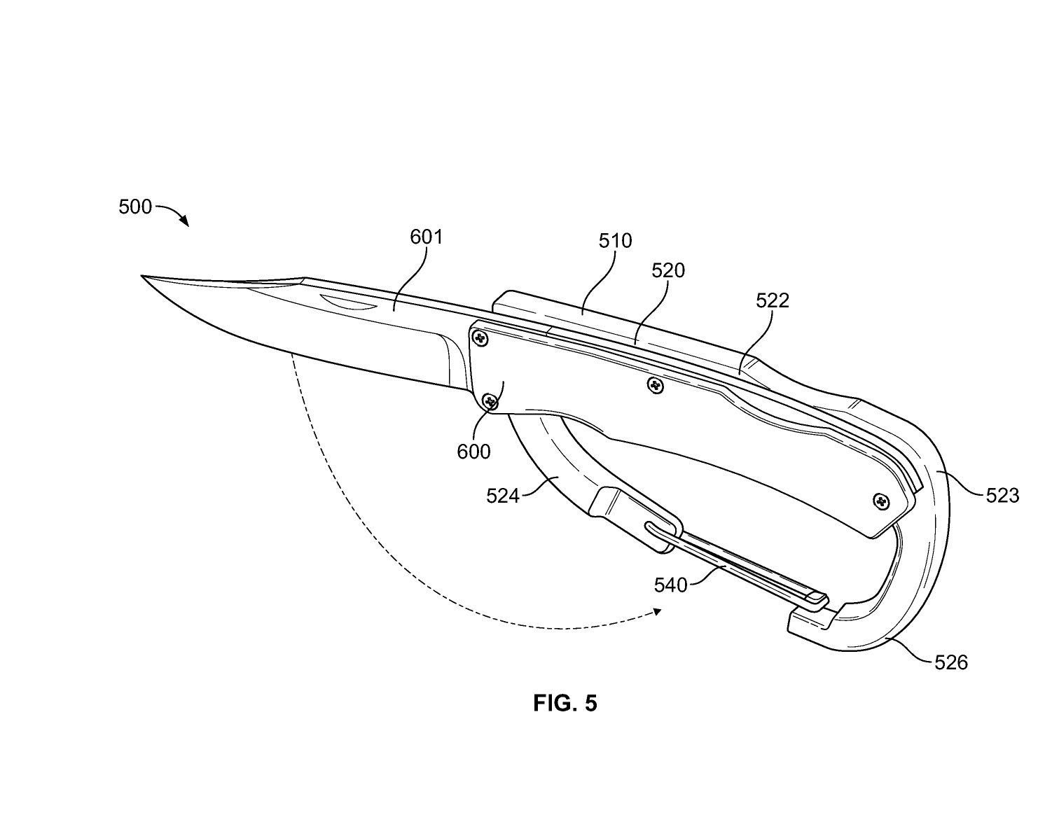

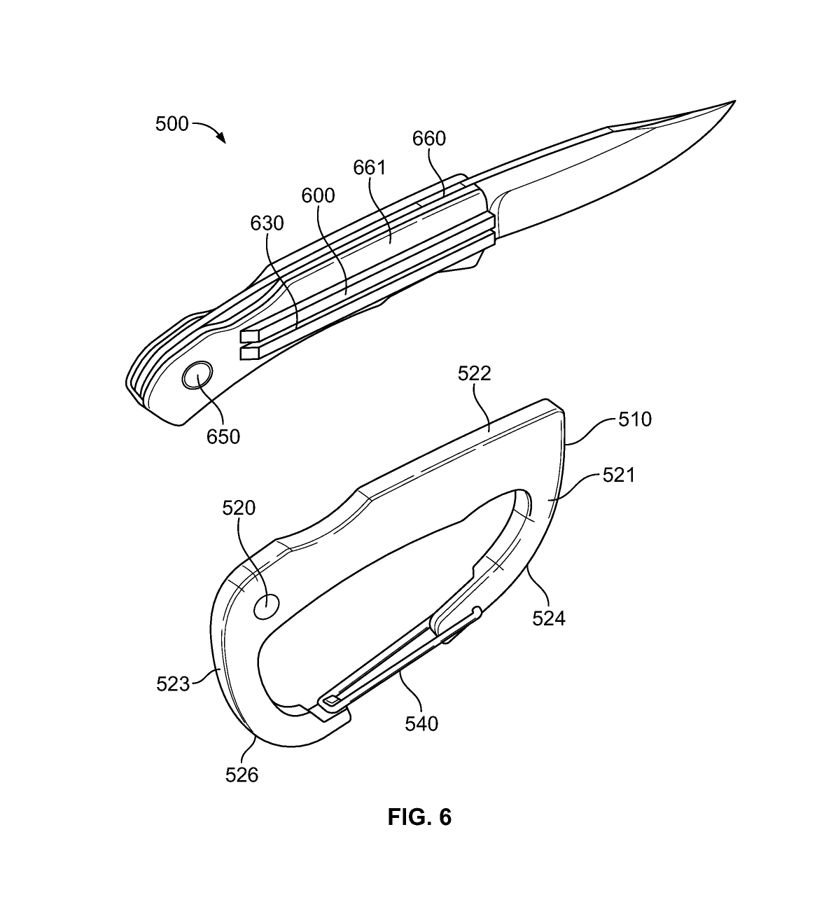

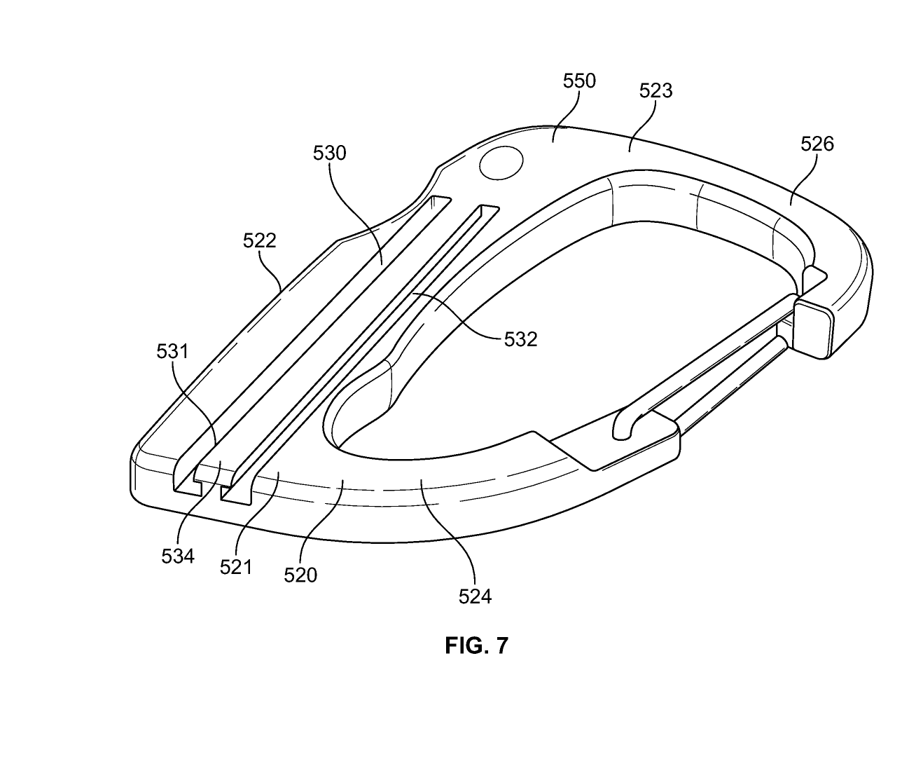

FIG. 5 is a perspective view of a combination carbineer and tool 500, such as a knife 600, according to an example embodiment. FIG. 6 is a perspective view of a tool, such as a knife 600, separated from the carbineer 510, according to an example embodiment. FIG. 7 is a perspective view of an attachment side of the carbineer, according to an example embodiment. Now referring to both FIGS. 5, 6 and 7, the combination carabineer 500 and tool 500 will be further detailed. The carabineer and tool device 500 includes a tool 600, such as a knife, which is separable from the carabineer 510. The carabineer 510 includes a curvilinear body 520 having a first attachment portion 530 associated with the curvilinear body 520. The tool 600 includes a second attachment portion 630. The curvilinear body 520 further includes an elongated handle member 522 with a first end 521 and a second end 523. The curvilinear body 520 has an upper arm member 524 integrally attached to the first end 521 of the elongated handle member 522, and a lower arm member 526 integrally attached to the second end 523 of the elongated handle member 522. A gate element 540 is movable between an open position and a closed position. When in the closed position, the gate element 540 connects the upper arm member 526 and the lower arm member 524.

The first attachment portion 530 is associated with the elongated handle 522 of the curvilinear body 520 of the carabineer 510. The second attachment portion 630 of the tool 600 is adapted to engage the first attachment portion 530. In one embodiment, the first attachment portion 530 and the second attachment portion 630 are elongated.

As shown in FIG. 7, the carabineer 510 includes the first attachment portion 530. The first attachment portion 530 includes a first channel 531 and a second channel 532. The channel 531 and the channel 532 are both substantially L-shaped. The first channel 531 and the second channel 532 are also substantially parallel to one another. The lower portion of the L shaped channels 531, 532 are spaced from one another within the curvilinear body 520 of the elongated handle 522 of the carabineer 510. The result is a T-shaped or I shaped feature 534 within the main body or curvilinear body 520 of the carabineer 510. The first channel 531 and the second channel 532 are in the elongated handle 522 of the carabineer 510.

Also within the curvilinear body 520 and positioned at one end of the first channel 531 and the second channel 532, is a first stop portion 550. The first stop portion 550 includes one of a magnet or portion of ferrous metal. A second stop portion 650 is provided in the tool 600. The second stop portion 650 is the other of a magnetic portion or ferrous metal and is located near the end of the second attachment portion 630. It should be understood that the first stop portion 550 and the second stop portion 650 could both be magnetic or magnets. The first portion 550 and the second stop portion 650 limits or holds the tool 600 with respect to the carabineer 510. In other words, when the second attachment portion 630 is engaged with the first attachment portion 530 of the carabineer 510, the first stop portion 550 and the second stop portion 650 engage and hold the tool 600 in a position with respect to the carabineer 510. The stop portions 650 and 550 are not necessarily limited to a magnet and a ferrous portion. Other arrangements could be used to stop or limit the length of travel of the tool 600 with respect to the carabineer 510. For example, a detent could be used or a physical stop could be used to limit the amount of travel or stop the tool with respect to the carabineer 510.

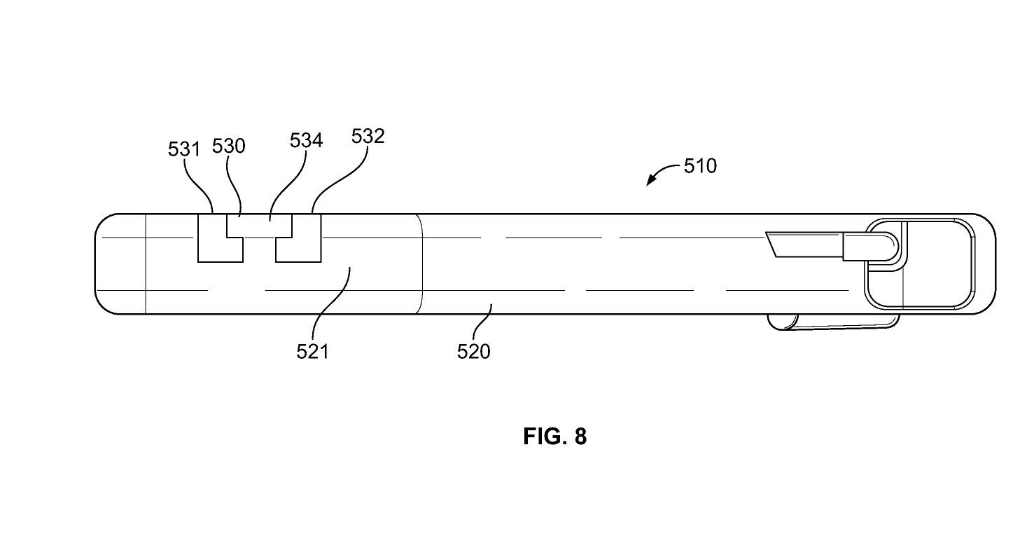

FIG. 8 is a view of the carabineer 510 from the first end 521 of the elongated handle 522, according to an example embodiment of the invention. The first channel 531 and the second channel 532 are open near the first and 521 of the elongated handle elongated handle 522. The first channel 531 is L-shaped. The second channel 532 is L-shaped. The second channel 532 has a backwards L-shaped cross section. This results in a T-shaped portion 534 between the first channel 531 and the second channel 532. A tool (shown in FIGS. 5 and 6) and more particularly the second attachment portion 630 of the tool 600 fits within the first channel 531 and the second channel 532. The tool 600 slips or passes through the first channel 531 and the second channel 532 until it hits the first stop portion and the second stop portion, 550, 650, respectively. Although specific types of cross sectional shapes are set forth above, it should be noted that the channels and the projections can also have different types of cross sectional shapes and be equally effective.

Returning briefly to FIG. 6, the tool or knife 600 includes the second attachment portion 630. The second attachment portion 630 includes a first projection 631 and a second projection 632. The first projection 631 and the second projection 632 are elongated. In another embodiment the first projection 631 and the second projection 632 could be formed from several unattached portions. In other words, the first projection 631 can be formed of several aligned sub portions. Similarly the second projection 632 can be formed of several aligned sub portions. The first projection 631 is also L-shaped. The first projection 631 is dimensioned so that it fits within the channel 531 of the carabineer 510 the second projection 632 is also L-shaped and fits within the channel 532 of the carabineer 510.

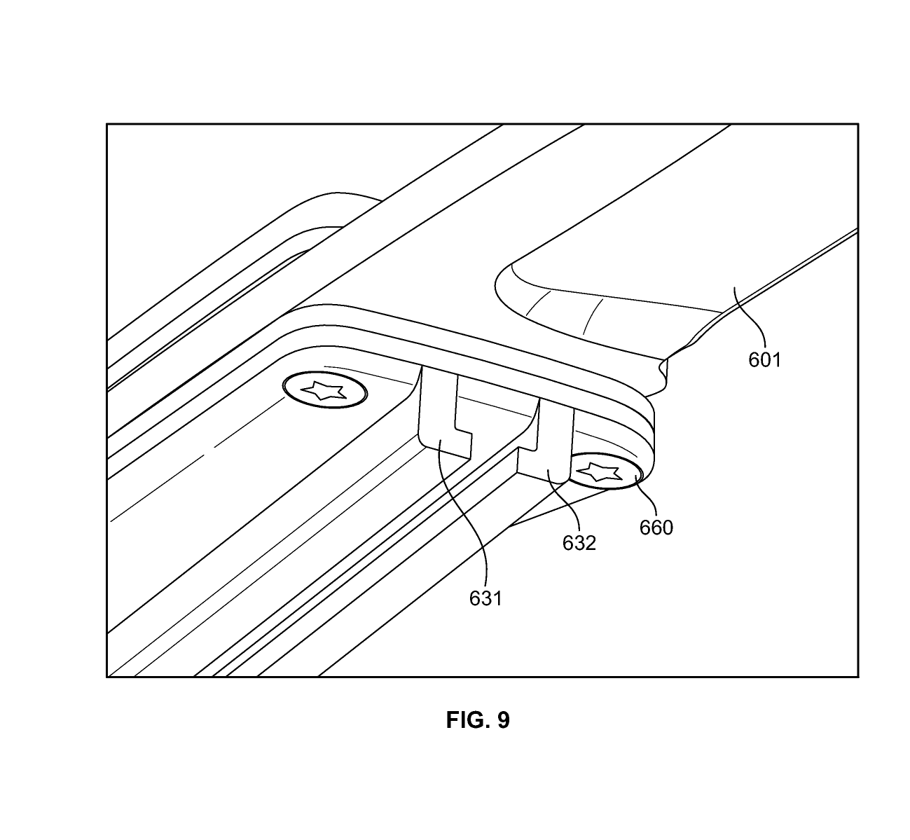

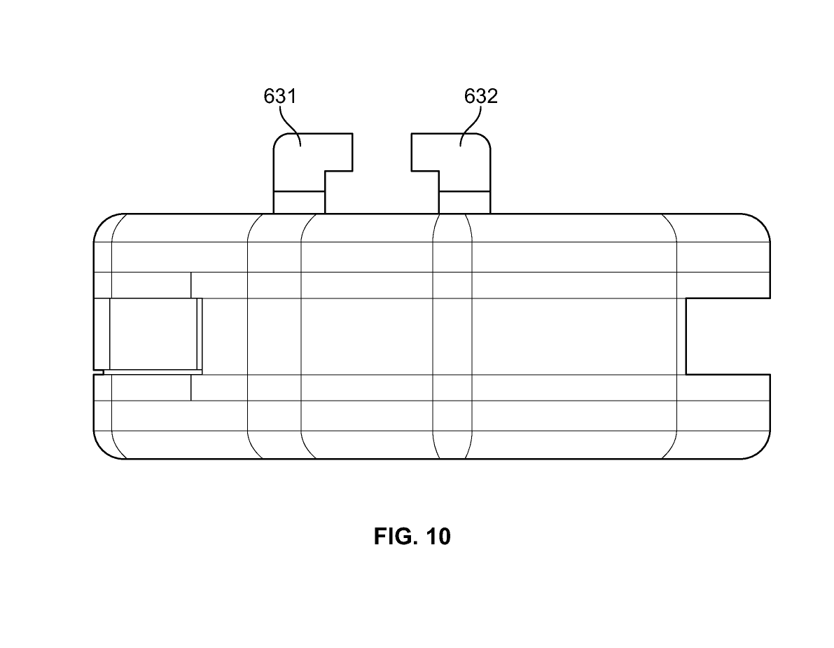

As shown in FIG. 6, the second attachment portion 630 and the first projection 631 and the second projection 632 are positioned along the one side 661 of a main body 660 of the tool 600. FIG. 9 is a close up perspective view of a tool, such as a knife 600, showing one end of the projection or projections 631, 632, according to an example embodiment. FIG. 10 is a close up perspective view of a tool, such as a knife 600, showing another end of the projection or projections 631, 632, according to an example embodiment. FIG. 10 shows the end of the main body 660 nearest the knife blade 601. The projections 631, 632 are L-shaped and are substantially parallel to one another. The other end of the knife body is shown in FIG. 10. Again the projection 631 632 are shown as L-shaped and parallel to one another. The projections 631, 632 are dimensioned so that they fit within the channels 531, 532 of the carabineer 510. In other words, the projection 631 632 are dimensioned so that they correspond to the dimensions of the channels 531, 532 of the carabineer 510. In this manner the tool or knife 600 can be easily of attached and removed from the carabineer 510. The stop portion 550 and the stop portion 650 engage one another along the length of travel of the tool 600 as it passes through the channels 531 532 of the carabineer 510. More specifically the stop portion 550 and the stop portion 650 engage one another to stop the travel of the tool 600 with respect to the carabineer 510. The stop portions 550, 650 also have a holding force which holds the tool 600 with respect to the carabineer 510.

FIG. 5 shows the tool or knife 600 having a knife blade 601 capable of moving between an open position and a stored position. As shown in FIG. 5 the knife blade 601 is an and open or deployed position. The tool or knife 600 is attached to the carabineer 510 such that they knife blade 601, when moving between an open or deployed position and a closed position, passes proximate the gate 540 of the carabineer 510. A dotted line 560, which also includes an arrow, shows the path of the knife tip as it moves from an open position to a closed position. In other words the knife blade 601 passes over the gate 540 and the space between the lower arm 524 of the upper arm 526 and the elongated handle 522. It should be noted that the tool or knife 600 can be attached so that the knife blade 601 does not pass near the gate 540 the lower arm 524 and the upper arm 526.

A carabineer device 510 includes a curvilinear body 520 which also has an elongated handle member 522. The curvilinear body 520 also includes a first end 521 and a second end 523. An upper arm member 526 is integrally attached to the first end 521 of the elongated handle member 522, and a lower arm member 524 is integrally attached to the second end 523 of the elongate handle member 522. The carabineer device 510 also includes a gate element 540 capable of moving between an open position and a closed position. The gate element connects the upper arm member 524 and the lower arm member 526 when in the closed position. The carbineer device 510 also includes an attachment portion 530 associated with the elongated handle 522. The attachment portion 530 is adapted to mate with another body. In one embodiment, the attachment portion 530 is elongated. The attachment portion is an elongated projection, in one embodiment, or an elongated channel in another embodiment. In one embodiment, there is a single elongated channel. In other embodiments there are multiple elongated channels. In still other embodiments, there can be portions of channels which are aligned. In other embodiments there may be projections. Projections can be aligned. There can also be a single projection or multiple projections which formed the attachment portion 530. The projection as well as the channel can feature a cross sectional shape of any type. In one embodiment, the elongated projection has an I-shaped or T-shaped cross section. The elongated channel has a corresponding I-shaped or T-shaped cross section so that the projection fits within the channel.

A carabineer and knife device includes a substantially C-shaped carabineer body and a foldable knife. The carabineer body has a first free end and a second free end. The foldable knife is associated with the carabineer. The foldable knife is movable between a storage position and a deployed position. When moving between these positions, the knife blade passes near the first free end and the second free end of the carabineer body. The foldable knife is removably attached to the carabineer. The carabineer body has one of a projection or a slot. The foldable knife has the other of the projection or the slot. The foldable knife is removably attached by engaging the projection with the slot. The carabineer and knife wherein at least one of the carabineer or the foldable knife includes an apparatus to hold the knife in a position with respect to the carabineer.

A carabineer and tool device includes a curvilinear body, a first attachment portion associated with the curvilinear body, and a tool including a second attachment portion. The curvilinear body further includes an elongated handle member with a first end and a second end. The curvilinear body has an upper arm member integrally attached to the first end of the elongated handle member, and a lower arm member integrally attached to the second end of said handle member. A gate element is movable between an open position and a closed position. When in the closed position, the gate element connects the upper arm member and the lower arm member, when in the closed position. The first attachment portion is associated with the elongated handle of the curvilinear body. The second attachment portion of the tool is adapted to engage the first attachment portion. The first attachment portion and the second attachment portion are elongated, according to one embodiment. The first attachment portion is one of an elongated channel or an elongated projection, and the second attachment portion is the other of an elongated channel or an elongated projection. In one embodiment, the elongated projection has an I-shaped or T-shaped cross section. The elongated channel has a corresponding I-shaped or T-shaped cross section so that the projection fits within the channel.

A carabineer and knife device includes a substantially C-shaped carabineer body and a foldable knife. The carabineer body has a first free end and a second free end. The foldable knife is associated with the carabineer. The foldable knife is movable between a storage position and a deployed position. When moving between these positions, the knife blade passes near the first free end and the second free end of the carabineer body. The foldable knife is removably attached to the carabineer. The carabineer body has one of a projection or a slot. The foldable knife has the other of the projection or the slot. The foldable knife is removably attached by engaging the projection with the slot. The carabineer and knife wherein at least one of the carabineer or the foldable knife includes an apparatus to hold the knife in a position with respect to the carabineer.

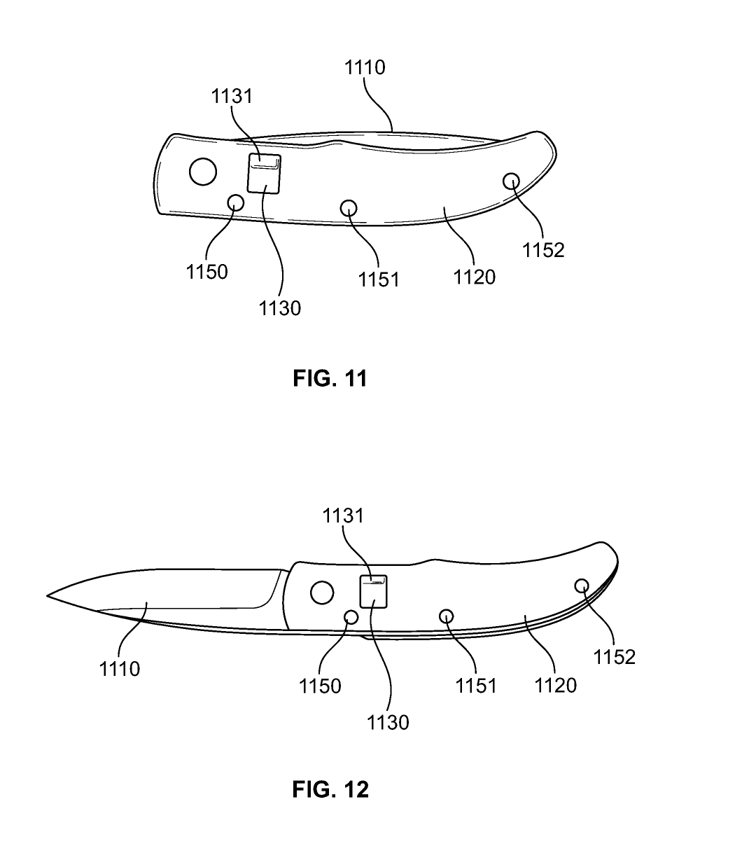

FIG. 11 is a side view of a folding knife 1100 with a blade 1110 of the folding knife 1100 in a closed or stored position, according to an example embodiment. The folding knife includes a handle 1120. The handle 1120 actually has two halves which are held together by pins or nails 1150, 1151 and 1152. The handle also includes a knob 1130 for moving a safety device or block 1430 (shown in FIG. 14) to allow the blade 1110 to move from an open, locked position to a closed position, which is shown in FIG. 11. Note that there is a knob edge 1131 which is proximate to the open edge of the handle 1120. The knob 1130 is in a first position in FIG. 11 and in a second position in FIG. 12 (described below).

FIG. 12 is a side view of a folding knife 1100 with the blade 1110 of the folding knife 1100 in an opened and locked position, according to an example embodiment. The blade 1110 includes a tang 1112 which is the end near the pivot point or opening 1114 in the blade 1110. The knob 1130 is in another position in FIG. 12, as noted above. The knob 1130 is connected to a safety device or block 1430. The knob is connected to the safety device through an opening (not shown) in the handle 1120. The opening (not shown) is positioned below the knob 1130 in FIGS. 11 and 12. Moving the knob 1130 from the position shown in FIG. 12 to the position in FIG. 11 allows the safety device or block 1430 (shown in FIG. 14) to be moved to allow the knife blade 1110 to move from its open and locked position to the closed position.

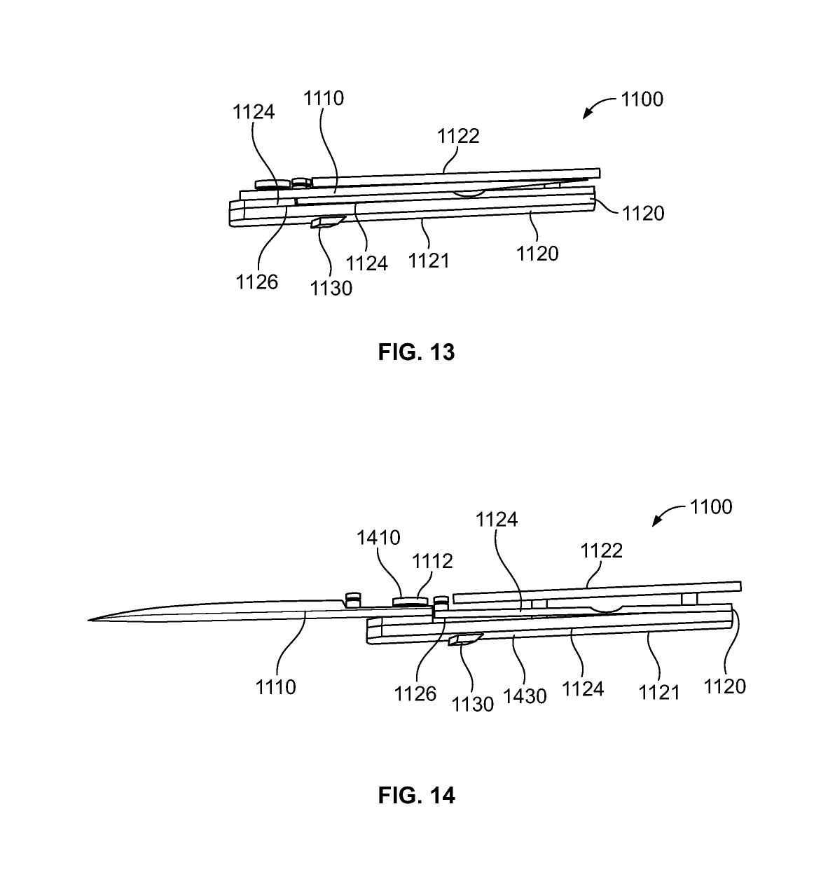

FIG. 13 is a top view of a folding knife 1100 with the blade 1110 of the folding knife 1100 in a closed or stored position, according to an example embodiment. The handle 1120 includes a first handle portion 1121 and a second handle portion 1122. The handle 1120 also includes a liner 1124 that also includes a liner lock 1126. The handle, as mentioned above, is held together by pins 1150, 1151, and 1152 (see FIGS. 11 and 12) or other fasteners. FIG. 13 also clearly shows the liner 1124 and the liner lock 1126. The liner lock 1126 is a lock that is incorporated into the liner 1124 of the handle 1120. The liner lock 1126 is a leaf spring which biases against the blade 1110 when in the blade is in a closed position. The leaf spring 1126 of the liner 1124 has an end which engages the tang of the knife blade 1110 when the blade is in the open position or deployed position. The tang is the back portion of the blade that extends from where the blade rotatably attaches to the handle to the start of the edge. The tang is the end opposite the blade of the knife. The tang end is shaped so that it engages the end of the liner lock and holds it in its deployed or open position. As shown here in FIG. 13, a spring is biased against the knife blade 1110 as indicated by the space between the liner lock 1126 and the handle portion 1121.

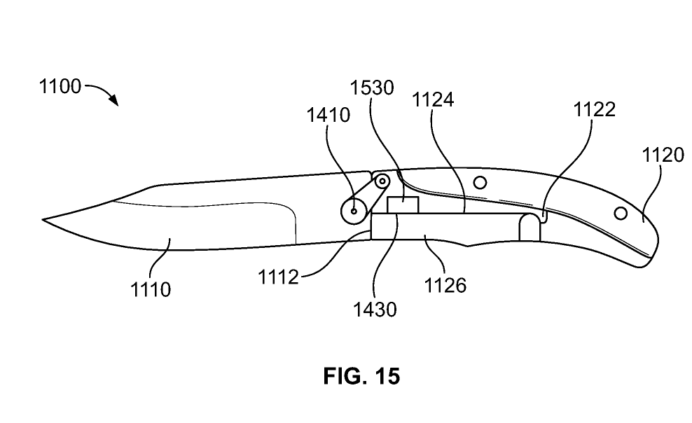

FIG. 14 is a top view of a folding knife 1100 with the blade 1110 of the folding knife in an opened and locked position, according to an example embodiment. As the knife blade 1110 is moved from a closed position to an open position, the tang portion 1112 of the knife blade 1110 rotates about a pivot point 1410 and positions the end of the tang 1112 to allow the liner lock 1126 and to engage the tang 1112. When in the appropriate position, the spring force of the end of the liner lock 1126 moves away from handle portion 1121 to which it is attached. The safety device 1430 is a block of material which is connected to a spring. When the liner lock 1126 moves away from the handle portion 1121 the spring (shown in FIG. 15) forces the block or safety device 1430 into a safety position between the handle portion 1121 and the liner lock 1126. The block can be of any shape, such as a rectangular block, wedge or the like. The block or safety device 1430 is attached to the knob 1130. When the blocker safety device 1430 is positioned between the handle portion 1121 and the liner lock 1126, the user is unable to move the knife blade from an open position to a closed position. In fact, little movement, if any, is allowed. The block 1430 acts as a further safety device to prevent the blade 1110 from moving from its open position. To move the blade 1110 from an open position or deployed position to a closed position it is required that the liner lock 1126 the move or be disengaged from the tang 1112 of the knife blade 1110. In order to accomplish this, a user must move the block 1430 from its position between the liner lock 1126 and the handle portion 1121 (or liner) by moving the knob 1130 which is attached to the block 1430. Moving the knob 1130 also causes the block 1430 compress the attached spring (shown in FIG. 15). Once the block 1430 is moved from is positioned between the liner lock 1126 and the handle 1121 (and more specifically the liner), the liner lock 1126 can be moved to a position proximate the handle portion 1121 which in turn disengages the liner lock 1126 from the tang 1112 to allow the blade 1110 to be moved from its deployed or open position.

FIG. 15 is another side view of a folding knife 1100 with the blade 1110 of the folding knife in an opened and locked position, according to an example embodiment. The folding knife 1100 is shown from the opposite side of the knife as that shown in FIG. 12. In other words, the folding knife 1100 is shown from the handle side 1122. As can be seen, the liner lock 1126 is a portion of the liner 1124. There is an opening within the liner 1124 that accommodates the movement of the safety block 1430. Also shown in FIG. 15 is a spring 1530 that is attached to the safety block 1430. The spring 1530 biases the safety block 1430 toward a position between the liner lock 1126 and the handle portion 1121 (shown in FIG. 14). The spring 1530 is attached at one end to the safety block 1430 and attached to another and to either the handle portion 1121 or a portion of the liner 1124. The spring is compressed when the block is positioned below or at the edge of the liner lock 1126, which corresponds to the closed position of the folding knife 1100. The block 1430 is biased toward the edge of the liner lock 1126 when in the closed position. When the blade 1110 is moved to a fully or substantially fully deployed position, the tang 1112 of the blade 1110 allows the liner lock 1126 to move from a position near the handle 1121 and into a position where the end of the liner lock 1126 engages the tang 1112 of the blade 1110. When the liner lock 1126 moves into engagement with tang 1112, the spring force 1530 forces or pushes the block 1430 to a position between the tang 1126 and the handle portion 1121. This safety block 1430 is now in a position where it acts as a further safety device to prevent inadvertent movement of the blade 1110 by inadvertent movement of the liner lock 1126.

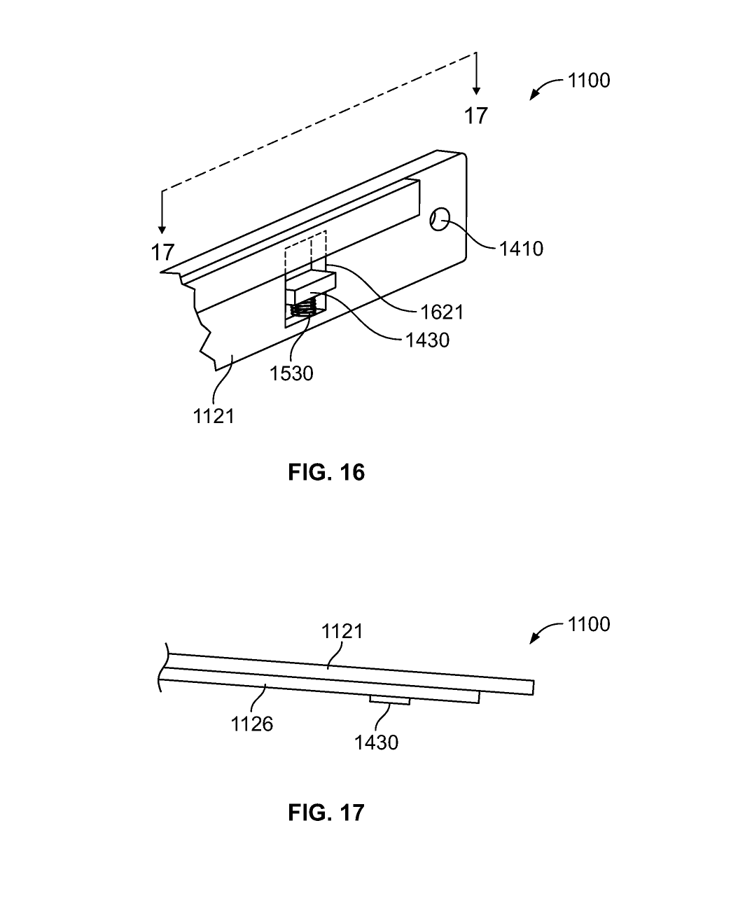

FIG. 16 is a perspective view of a portion of a folding knife with the blade in the closed position, according to an example embodiment. As shown, many of the elements of the folding knife 1100 have been removed so that the safety block 1430 and the spring 1530 can be more clearly shown and discussed. In this view, they knife blade 1110 and the liner 1124 as well as the handle portion 1122 are not shown. The handle portion 1121 includes a channel 1621 which is dimensioned to receive the block 1430. The dimensions of the channel 1621 allow the block 1430 to move within the channel 1621. The spring 1530 is compressed and attached to the handle 1121 or more specifically to a portion of the channel 1621 in the handle 1121. As shown in FIG. 16, the lock 1430 is biased against the edge of the liner lock 1126. The liner lock 1126 is in a position associated with a closed folding knife 1110. In other words, the liner lock 1126 generally moves to a position away from the handle portion 1121 when in an open position. Here, however, the folding knife 1100 is in a closed position and the knife blade 1110 which holds the knife blade to the pivot 1410 have been removed.

FIG. 17 is a top view of a portion of a knife with the blade in the closed position from line 17-17 of FIG. 16, according to an example embodiment. FIG. 17 is the knife 1100 in a closed position with the elements of the knife blade 1110, the handle portion 1122 and the pins for holding these two together removed from the view for the sake of clarity. When in the closed position the liner lock 1126 is positioned close or proximate the handle portion 1121. The safety device or block 1430 abuts the bottom edge or edge of the liner lock 1126. When viewed from the top, the safety device 1430 is positioned slightly above or beyond the closed position of the liner lock 1126. In other embodiments the safety block 1430 may not be visible from the view shown in FIG. 17. The block 1430 is dimensioned so that it maintains or keeps the liner lock in a position where it is engaged with attaining 1112 of the blade 1110.

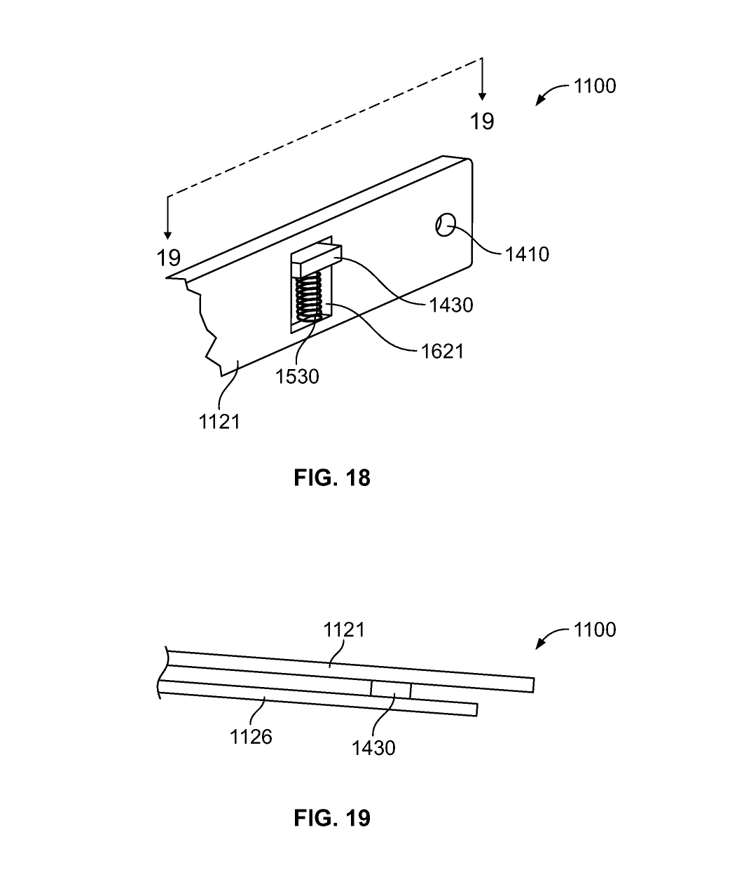

FIG. 18 is a perspective view of a portion of a knife 1100 with the blade 110 in the open and locked position, according to an example embodiment. As shown in FIG. 18, many of the portions of the knife 1100 have been removed for the sake of clarity and for the sake of discussion. In this particular view, the knife blade 1110, the liner lock 1126 and the handle portion 1122 have been removed. As shown in FIG. 18 this is the position of the safety block or safety device 1430 when the knife is in its deployed or open position. The safety block is biased to a position at the end of the channel 1621 and the handle 1121. When the safety block 1430 is in this position, the block 1430 is positioned between the handle 1121 and the liner lock 1126. The liner lock 1126 cannot be moved out of engagement with the attaining 1112 of the knife blade when the safety block or safety device 1430 is in the position shown in FIG. 18 or in its safety position. The spring 1530 biases the safety block 1430 to a position at the end of the channel 1621.

FIG. 19 is a top view of a portion of a knife along line 19-19 in FIG. 18, with the blade in the open and locked position, according to an example embodiment. Again many portions of the knife 1100 have been removed from the FIG. 19. FIG. 19 shows that the liner lock 1126 is maintained in its position away from the handle portion 1121 by the safety block 1430. When the safety block 1430 is in this position, it must be moved before the liner lock 1126 can be moved. In other words the safety block or safety device 1430 prevents movement of the liner lock 1126 and therefore acts as an additional safety device to prevent the knife blade 1110 from inadvertently closing or moving from an open position to a closed position.

A folding knife includes a handle, a knife blade rotatably attached to the handle, the knife blade including a tang, a liner positioned within the handle, the liner further comprising a liner lock, and a safety device. The liner lock has a first position when the knife is in a closed position, and has a second position when the knife blade is in a deployed or open position. An end of the liner lock engages the tang of the knife. A safety device is positioned between the liner lock and the handle when the knife blade is in the deployed or open position. A knob attached to the safety device. The knob accessible at a position on an exterior surface of the handle. The knob is used to move the safety device from a position between the liner lock and the handle to allow the liner lock to be moved to the first position. A biasing device is attached to the block. The biasing device is positioned to bias the block to a position between the liner lock and the handle. In one embodiment, the biasing device is a spring attached at one end to the safety device and attached at another end to the handle. In some embodiments the handle includes an opening therein. The opening is dimensioned to allow the safety device to slide within the opening. The safety device can be a block, or a wedge, or the like.

A folding knife includes a handle, a knife blade rotatably attached to the handle, a liner positioned within the handle, a liner lock having a first position when the knife is in a closed position, and having a second position when the knife blade is in a deployed or open position. The knife blade includes a tang. The free end of the liner lock engages the tang of the knife to substantially prevent motion of the knife blade with respect to the handle. A safety device is positioned between the liner lock and the liner of the handle when the knife blade is in the deployed or open position. The liner lock is a leaf spring having one end attached to the liner of the handle and a free end shaped to engage the tang of the knife blade when the knife blade is in a deployed position with respect to the handle. The safety device is biased by a spring having one end attached to a handle portion and the other end attached to the safety device. The spring is positioned to bias the safety block to a position between the liner lock and the liner of the handle to maintain the liner lock in a position where the end of the liner lock is engaged with the tang of the knife blade. The safety device includes a portion that extends through the handle of the knife so that the safety device can be disengaged from the liner lock. The portion extending through the handle includes a knob positioned near an exterior surface of the handle of the folding knife. The liner lock can be moved to a position near the liner of the handle after the safety device has been substantially disengaged from the liner lock.

A method includes attaching one end of a a liner lock to a liner within the handle of a folding knife, the liner lock formed as a leaf spring biased toward the blade of the folding knife when the blade is in an undeployed position, forming the end of the liner lock so that it engages a tang end of the knife blade which is rotatably attached to the handle of the folding blade, said liner lock engaging the tang end of the knife blade into a substantially locked position when the knife blade is in a deployed position, and placing a safety device between the liner lock and the liner of the handle to substantially prevent movement of the liner lock with respect to the line when the liner lock moves to engage the tang end of the knife blade. Placing the safety device between the liner lock and the liner of the handle includes biasing the safety device to the position between the liner and the liner lock. The safety block is provided with a portion near the exterior of the knife handle for removing the safety device from a position between the handle and the liner lock.

This has been a detailed description of some exemplary embodiments of the invention(s) contained within the disclosed subject matter. Such invention(s) may be referred to, individually and/or collectively, herein by the term “invention” merely for convenience and without intending to limit the scope of this application to any single invention or inventive concept if more than one is in fact disclosed. The detailed description refers to the accompanying drawings that form a part hereof and which shows by way of illustration, but not of limitation, some specific embodiments of the invention, including a preferred embodiment. These embodiments are described in sufficient detail to enable those of ordinary skill in the art to understand and implement the inventive subject matter. Other embodiments may be utilized and changes may be made without departing from the scope of the inventive subject matter. Thus, although specific embodiments have been illustrated and described herein, any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed:

1. A folding knife comprising:
a handle;
a knife blade rotatably attached to the handle, the knife blade including a tang;
a liner positioned within the handle, the liner further comprising a liner lock having a first position when the knife is in a closed position, and having a second position when the knife blade is in a deployed or open position, an end of the liner lock engaging the tang of the knife; and
a safety device positioned between the liner lock and the handle when the knife blade is in the deployed or open position.

2. The folding knife of claim 1 further comprising a knob attached to the safety device, the knob accessible at a position on an exterior surface of the handle.

3. The folding knife of claim 2 wherein the knob can be used to move the safety device from a position between the liner lock and the handle to allow the liner lock to be moved to the first position.

4. The folding knife of claim 2 further comprising a biasing device attached to the block, the biasing device positioned to bias the block to a position between the liner lock and the handle.

5. The folding knife of claim 4 wherein the biasing device is a spring attached at one end to the safety device and attached at another end to the handle.

6. The folding knife of claim 2 wherein the handle includes an opening therein, the opening dimensioned to allow the safety device to slide within the opening.

7. The folding knife of claim 2 wherein the safety device is a block.

8. The folding knife of claim 2 wherein the safety device is a wedge.

9. A folding knife comprising:
a handle;
a knife blade rotatably attached to the handle, the knife blade including a tang;
a liner positioned within the handle;
a liner lock having a first position when the knife is in a closed position, and having a second position when the knife blade is in a deployed or open position, an end of the liner lock engaging the tang of the knife to substantially prevent motion of the knife blade with respect to the handle; and
a safety device positioned between the liner lock and the liner of the handle when the knife blade is in the deployed or open position.

10. The folding knife of claim 9 wherein the liner lock is a leaf spring having one end attached to the liner of the handle and a free end shaped to engage the tang of the knife blade when the knife blade is in a deployed position with respect to the handle.

11. The folding knife of claim 9 wherein the safety device is biased by a spring having one end attached to a handle portion and the other end attached to the safety device.

12. The folding knife of claim 11 wherein the spring is positioned to bias the safety block to a position between the liner lock and the liner of the handle to maintain the liner lock in a position where the end of the liner lock is engaged with the tang of the knife blade.

13. The folding knife of claim 9 wherein the safety device includes a portion that extends through the handle of the knife so that the safety device can be disengaged from the liner lock.

14. The folding knife of claim 13 wherein the portion extending through the handle includes a knob positioned near an exterior surface of the handle of the folding knife.

15. The folding knife of claim 10 wherein the liner lock can be moved to a position near the liner of the handle after the safety device has been substantially disengaged from the liner lock.

16. A method comprising:
attaching one end of a liner lock to a liner within the handle of a folding knife, the liner lock formed as a leaf spring biased toward the blade of the folding knife when the blade is in an undeployed position;
forming the end of the liner lock so that it engages a tang end of the knife blade which is rotatably attached to the handle of the folding blade, said liner lock engaging the tang end of the knife blade into a substantially locked position when the knife blade is in a deployed position; and
placing a safety device between the liner lock and the liner of the handle to substantially prevent movement of the liner lock with respect to the line when the liner lock moves to engage the tang end of the knife blade.

17. The method of claim 16 wherein placing the safety device between the liner lock and the liner of the handle includes biasing the safety device to the position between the liner and the liner lock.

18. The method of claim 16 wherein the safety block is provided with a portion near the exterior of the knife handle for removing the safety device from a position between the handle and the liner lock.
